(19) United States
(12) Patent Application Publication
(10) Pub. No.: US 2018/0075259 A1
(43) Pub. Date: Mar. 15, 2018

(54) SYSTEMS AND METHODS FOR SECURE MACHINE FOR HARDWARE SECURITY MODULE (HSM) ADAPTER

(71) Applicant: CAVIUM, INC., San Jose, CA (US)

(72) Inventors: Ram Kumar Manapragada, Hydearabad (IN); Biju Abraham, Kerala (IN)

(21) Appl. No.: 15/268,442

(22) Filed: Sep. 16, 2016

Related U.S. Application Data
(60) Provisional application No. 62/220,175, filed on Sep. 17, 2015.

(51) Int. Cl. G06F 21/72

(52) U.S. Cl. CPC G06F 21/72

(57) ABSTRACT

A new approach is proposed that contemplates systems and methods to support a secure machine environment on a HSM adapter, which enables an end user of the HSM adapter to run its own security sensitive applications securely via a secure machine within the HSM adapter and to gain access to its security measures. During operation, the secure machine receives commands from an application running on a host outside of the HSM adapter and executes a security sensitive application within the secure machine environment. The secure machine is configured to process all sensitive information of the security sensitive application via one or more secure machine processes/threads, while the applications running on the host only deal with non-sensitive information. The secure machine then sends a response back to the application running on the host following execution of the security sensitive application within the secure machine environment.

### CROSS-REFERENCE TO RELATED APPLICATIONS

This application claims the benefit of U.S. Provisional Patent Application No. 62/220,175, filed Sep. 17, 2015, and entitled “Secure Machine for Hardware Security Module (HSM) Adapter,” which is incorporated herein in its entirety by reference.

### BACKGROUND

A hardware security module (HSM) is a physical computing device that safeguards and manages digital keys for strong authentication and provides crypto processing. A HSM adapter is an PCIe adapter that addresses stringent security requirements of, for non-limiting examples, SaaS applications, ecommerce payment systems and Enterprise, Banking and Government security applications especially as they migrate to the public or private cloud. In some embodiments, HSM adapter is FIPS 140-2 Level 3 certified and uses tamper-resistant detection circuitry and strong enclosures to protect all the information stored on the HSM adapter.

Using the HSM adapter, however, requires applications and driver(s) to communicate across the PCIe bus, which is insecure and allows an attacker to gain access to and manipulate the flow of information between the applications, drivers and the HSM adapter at various points. Consequently, a user is not guaranteed that the applications and the drivers are secure and the user cannot trust them to handle sensitive information. There is a need for a secure environment that allows users to be able to run their applications securely within the HSM adapter and to be able to communicate with the HSM adapter without worrying about the security of their applications.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 depicts an example of a diagram of system 100 to support a secure machine environment on a HSM adapter in accordance with some embodiments.

FIG. 2 depicts an example of hardware implementation 200 of the HSM depicted in FIG. 1 in accordance with some embodiments.

FIG. 3 depicts an example of two secure machine processes registering opcodes with the secure machine driver in accordance with some embodiments.

FIG. 4 depicts an example of a flowchart for flow of data packet having the opcode from the HSM PCIe driver of the host to the secure machine driver of the secure machine environment across PCIe bus in accordance with some embodiments.

FIG. 5 depicts an example of a flowchart for performing a system call to the secure machine driver to check for received packet in accordance with some embodiments.

FIG. 6 depicts a flowchart of an example of a process to support a secure machine environment on a HSM adapter in accordance with some embodiments.

### DETAILED DESCRIPTION

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

A new approach is proposed that contemplates systems and methods to support a secure machine environment on a HSM adapter, which enables an end user of the HSM adapter to run its own security sensitive applications securely within the HSM adapter and to gain access to its security measures. Here, the secure machine environment is an operating system (OS) environment on the HSM adapter that allows the user to run a secure machine for its applications. During operation, the secure machine receives commands from an application running on a host outside of the HSM adapter and executes a security sensitive application within the secure machine environment. The secure machine is configured to process all sensitive information of the security sensitive application via one or more secure machine processes/threads, while the applications running on the host only deal with non-sensitive information. The secure machine then sends a response back to the application running on the host following execution of the security sensitive application within the secure machine environment.

Under the proposed secure machine environment on the HSM adapter, a security sensitive application running in the secure machine environment on the HSM adapter is signed using the private key of its user/owner to ensure its integrity. The code for the security sensitive application running in the secure machine environment is protected and is not exposed outside of the secure machine environment. As such, the user can implement its own private algorithms in the application running in the secure machine environment with full confidence that no other third party can access the code for the application. In addition, the application running in the secure machine environment can be stopped or started only by a privileged user authenticated under strict authentication protocols (e.g., FIPS 140-2 security level 3) enforced by the HSM adapter.

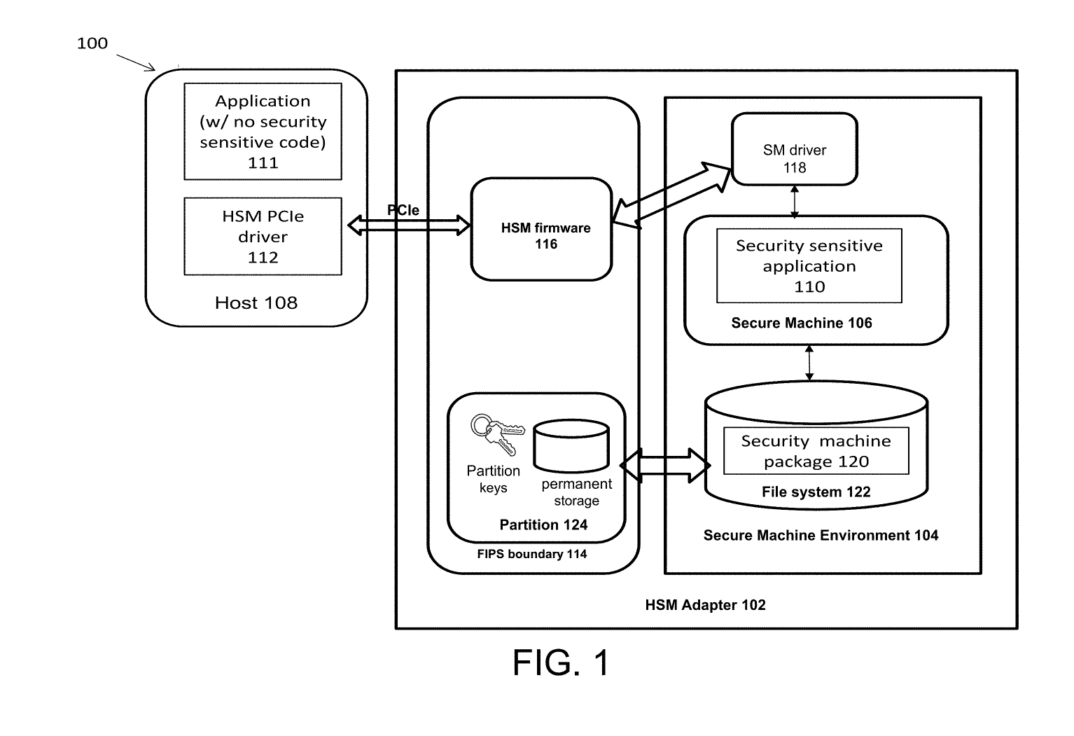

FIG. 1 depicts an example of a diagram of system 100 to support a secure machine environment on a HSM adapter. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

In the example of FIG. 1, the system 100 includes at least a HSM adapter 102 having at least a secure machine environment 104 running on it. In some embodiments, the HSM adapter 102 is a multi-chip embedded hardware/firmware cryptographic module having software, firmware, hardware, or another component that is used to effectuate a purpose. In some embodiments, the HSM 102 adapter is certified under Federal Information Processing Standard (FIPS) for performing secured key management cryptographic operations.

In the example of FIG. 1, the HSM adapter 102 is configured to provide a FIPS 140-2 overall Level 3 certified security solution to a plurality of users for their security sensitive applications 110. For a non-limiting example, the ephemeral keys, parameters, and secret used by the security sensitive applications 110 can be stored and maintained in the secure machine environment 104 on the HSM adapter 102. The applications 111 with no security sensitive code run on a host 108, which can be a computing device, a communication device, a storage device, or any electronic device capable of running one ore software components. For non-limiting examples, a computing device can be but is not limited to a laptop PC, a desktop PC, a tablet PC, or an x86, OCTEON, or ARM based device/system/server running Linux or other operating systems. Here, HSM adapter 102 and the host 108 are configured to communicate with each other over a communication interface (not shown) such as a high-speed Peripheral Component Interconnect Express (PCIe) bus coupled between the HSM adapter 102 and the host 108 via HSM PCIe driver 112. The PCIe bus is a high-speed serial computer expansion bus designed to support hardware I/O virtualization and to enable maximum system bus throughput, low I/O pin count and small physical footprint for bus devices.

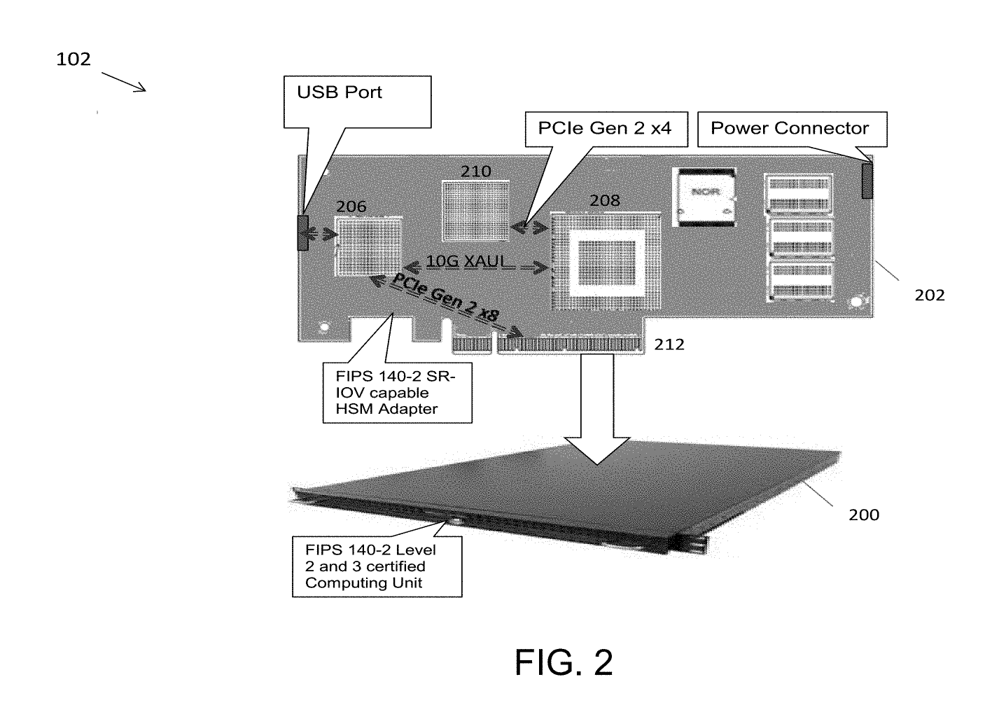

FIG. 2 depicts an example of hardware implementation of the HSM adapter 102 depicted in FIG. 1. As shown in the example of FIG. 2, the FIPS 140-2 Level 3 certified computing unit HSM appliance 200 includes one or more CPUs, RAM, and storage unit. The HSM appliance 200 further includes a FIPS-certified SR-IOV-capable HSM adapter 202, which further includes an SR-IOV PCIe bridge 206 connecting the HSM adapter 202 to the CPUs via a first PCIe connection (e.g., PCIe Gen2×8), wherein PCIe is a high-speed serial computer expansion bus standard designed to support hardware I/O virtualization to enable maximum system bus throughput, low I/O pin count and a small physical footprint for bus devices. The bridge 206 is further configured to connect to a multi-core processor 208 (e.g., a multi-core MIPS64 processor such as OCTEON CN6160) of the HSM adapter 202 across a high speed communication interface (e.g., 10G XAUI Interface). The HSM adapter 202 further includes a security processor 210 (e.g., NITROX CNN3560) via a second PCIe connection (e.g., PCIe Gen 2×4), wherein the security processor 210 is configured to enable cryptographic acceleration by performing crypto operations with hardware accelerators and embedded software implementing security algorithms. In some embodiments, the HSM appliance 200 is supplied and preconfigured with default network and authentication credentials so that the HSM appliance 200 can be FIPS/Common Criteria/PCI compliant.

In the example of FIG. 1, the secure machine environment 104 is an OS environment on the HSM adapter 102, which sets up all necessary security features to allow a secure machine 106 to run inside of it. Here, the OS environment can be but is not limited to Security-Enhanced Linux (SELinux), which is a Linux kernel security module that provides a mechanism for supporting access control security policies, including mandatory access controls (MAC). In some embodiments, since the secure machine environment 104 runs outside the FIPS boundary 114 of the HSM adapter 102 as shown in FIG. 1, it may only access keys, contexts, and other resources maintained inside the FIPS boundary 114 of the HSM adapter 102 using handles, which are reference numbers to resources inside the FIPS boundary 114. For a non-limiting example, a key handle is a unique number that represents a particular key stored inside the FIPS boundary 114. In some embodiments, the secure machine environment 104 is bound to a specific partition 124 of the HSM adapter 102, wherein the partition 124 is a block of resources inside the FIPS boundary 114 of the HSM adapter 102. Note that there can only be one secure machine environment 104 running at a time on the HSM adapter 102 and another secure machine environment 104 can start only after the current one has been stopped. The entire HSM adapter 102 will reboot when the secure machine environment 104 is initiated or stopped.

In the example of FIG. 1, the secure machine 106 includes running a secure machine initiation process and all the processes/threads that it spawns. All binaries/executables and files required to run the secure machine 106 are contained inside a secure machine package 120, which in some embodiments, is a compressed file that includes one or more of files in Executable and Linkable Format (ELF) to initialize (mark the start of) execution of the secure machine 106, shared libraries, and signature of the entire package signed using a private key. Here, ELF is a type of binary file that is a common standard file format for executables, object code, shared libraries, and core dumps. All Linux applications are of ELF format.

In order to be able to utilize the secure machine environment 104, the user needs to implement the code of its security sensitive applications 110 in C/C++ and compile the code to obtain the ELF files of the secure machine package 120 capable of being executed by the secure machine 106 on the HSM adapter 102. The user then digitally signs the ELF files and other files to be present on the HSM adapter 102 to create the secure machine package 120 for the secure machine 106 to run. Once the secure machine package 120 is created, it can be inserted by a partition Crypto Officer (pCO) and run on the HSM adapter 102. Here, pCO is a type of role (a user or a group of users who can perform certain actions) that allows managing a single partition such as creating, deleting users etc. In some embodiments, all secure machine packages 120 run within their own directories and they can access files within these directories only and run the applications 110 only from within these directories.

In some embodiments, the secure machine package 120 is sent to the HSM adapter 102 across PCIe, which can only be done when the secure machine 106 has been “created” by a master Crypto Officer (mCO), which is a type of role that allows managing partitions within a single HSM adapter 102 such as creating, deleting, resizing partitions etc. The HSM firmware 116 then verifies that the package 120 has been signed by the pCO's private key. Note that the secure machine package 120 only needs to be loaded once until either the mCO “destroys” the secure machine environment 104 or the pCO “unloads” the secure machine package 120. Unloading the secure machine package 120 automatically stops the secure machine 106 and removes the secure machine package contents for the partition, which allows loading of another secure machine package in the secure machine environment 104.

In some embodiments, the secure machine 106 is configured to receive commands from the applications 111 (with no security sensitive code) running on the host 108 across the PCIe bus, send responses (of executing security sensitive application 110 on the secure machine 106) back to the applications 110 on the host 108 across the PCIe bus, and receive commands directly to and from the HSM firmware 116 in the FIPS boundary 114. These type of operations are discussed in details below. Note that, in some embodiments, every command sent or received to from outside of the secure machine environment 104 is logged in an audit log along with the session handle used by the secure machine 106 to perform the operation, wherein the audit log is used to verify if the secure machine 106 is running properly.

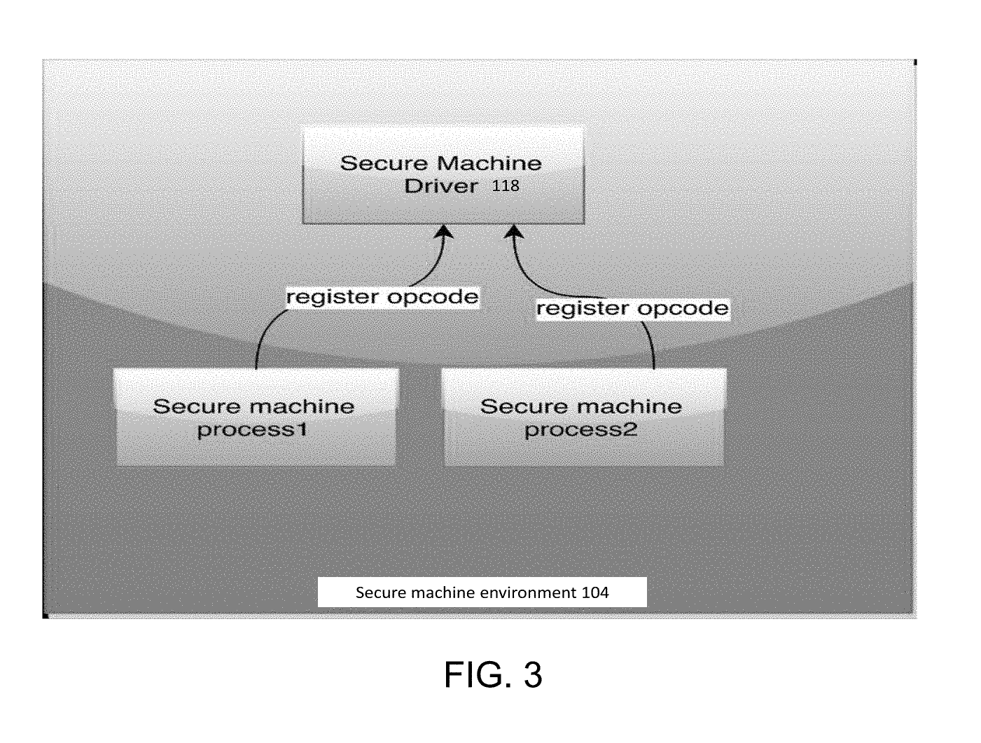

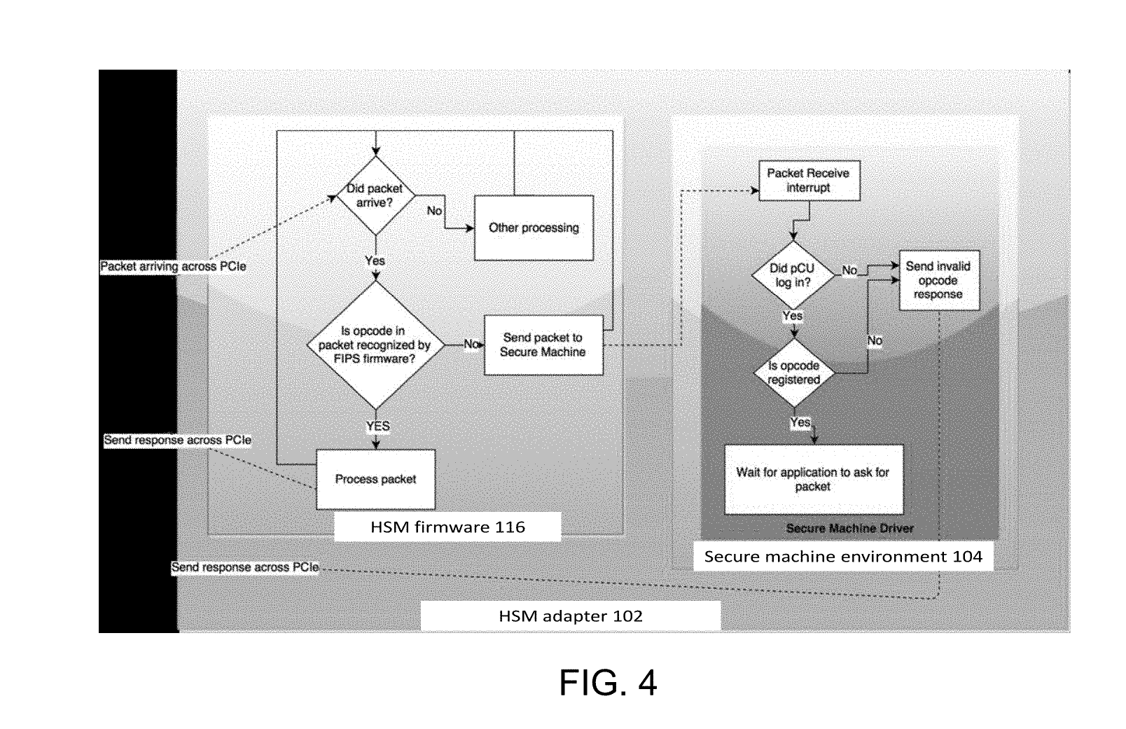

In some embodiments, the secure machine 106 is configured to register a plurality of opcodes that its processes/threads may receive with secure machine driver 118 of the HSM adapter 102 as shown by the example of FIG. 3. Although multiple processes/threads of the secure machine 106 can register to receive different opcodes, the same process/thread which registered for an opcode will have to poll in a loop to receive messages belonging to that opcode. In some embodiments, an opcode can be of two types: NO_RESPONSE and WAIT_FOR_RESPONSE. If an opcode is defined as NO_RESPONSE, the secure machine driver 118 will automatically send a response back the application 111 on the host 108 about the execution results of the security sensitive application 110 in the secure machine 106. If an opcode is defined as WAIT_FOR_RESPONSE, the secure machine processes will be required to send a response back to the application 111 on the host 108. Note that it is mandatory to register certain opcodes such as LOGIN (0xde) & LOGOUT (0xdf), which provide the session handle when a pCU logs in and indicate when a pCU logs out. Here, a partition Crypto User (pCU) is a type of role that allows user of the resources of a single partition to perform key management, encryption, decryption, etc. FIG. 4 depicts an example of a flowchart for flow of data packet having the opcode from the HSM PCIe driver 112 of the host 108 to the secure machine driver 118 of the secure machine environment 104 across PCIe bus.

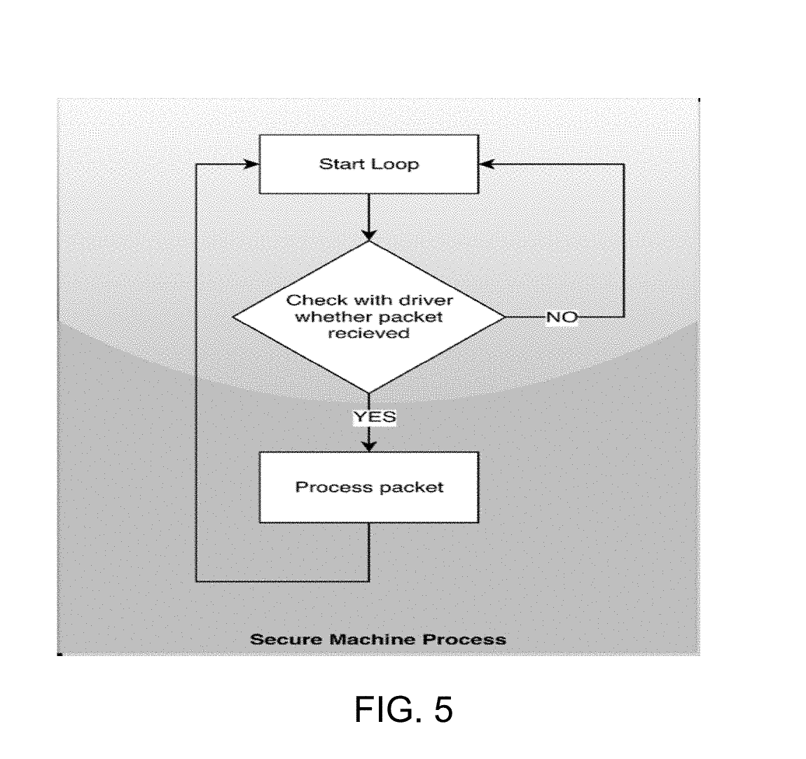

Once an opcode has been registered, the thread/process that has registered it will have to implement a receive loop (secure machine receive function), which performs a system call to the secure machine driver 118 to check for received packet as shown by the example of the flowchart of FIG. 5. In some embodiments, the receive loop includes as one of its parameters a request receive id or rx_id used when sending a response back to the host 106 so that the HSM PCIe driver 112 can redirect the response to the correct application 111 waiting for response. If an opcode is of type NO_RESPONSE, then an auto-response will be sent by the HSM PCIe driver 112 just before returning from the system call. If the opcode is of type WAIT_FOR_RESPONSE, then the secure machine 106 has to manually send the response by itself using the rx_id.

In some embodiments, the secure machine 106 can only send an response to the host 108 with the request receive id received when an application 111 from the host 108 sends a command to the secure machine 106. When the response is sent, this rx_id is used to redirect the response to the correct application 111 on the host 108 waiting for the response. In some embodiments, the secure machine 106 can only respond to messages that the applications 110 on the host 108 have initiated but cannot initiate a message to the applications 110 on the host 108.

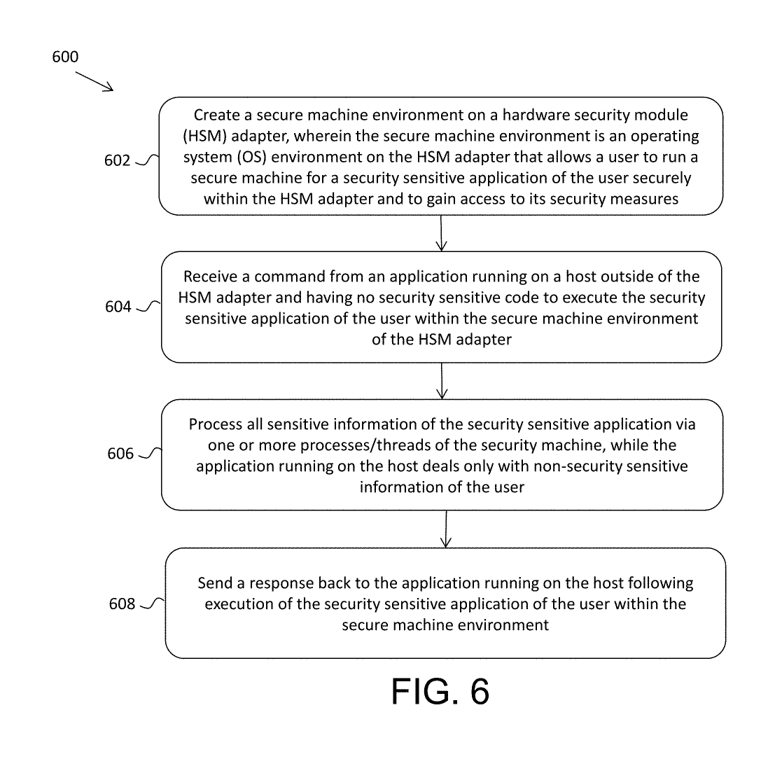

In some embodiments, the secure machine 106 is configured to send commands to the HSM firmware 116 in the FIPS boundary 114 via security Application Program Interface (API) of the HSM adapter 102, wherein the security API is modified to allow quick porting of existing applications 110 on the host 108 to run in the secure machine environment 104. All commands allowed to a pCU can be performed by the secure machine 106 with the exception of the following commands: app initialize, open session, login, logout, close session and app shutdown. FIG. 6 depicts an example of a flowchart for sending commands to the HSM firmware 116 in the FIPS boundary 114.

In some embodiments, the secure machine 106 can be booted up by starting the initializing ELF in the current secure machine environment 104, wherein the initialization process also spawns other processes/threads to perform other tasks of booting the secure machine 106. Note that the secure machine 106 can only be booted once the mCO has started the secure machine environment 104 and the pCO has loaded a secure machine package 120 in the secure machine environment 104.

In some embodiments, the secure machine 106 can be shut down together with all of its child processes and threads that it has started. the secure machine 106 first sends a command to the initialization process, and waits for the processes to exit themselves. On timeout, if the processes have not exited, another command is issued to all the processes and threads, which will only return until all of the secure machine processes have been shut down.

When a pCU intends to access the secure machine 106, the pCU has to login to the HSM firmware 116 in the FIPS boundary 114 to confirm his/her credentials, wherein the session handle is passed along to the secure machine process. Only after the pCU has logged in, the secure machine process will be able to receive commands and send responses from the HSM firmware 116 and across the PCIe bus. Once the login is complete, the secure machine 106 is completely functioning for the pCU and its applications 110 running on the secure machine 106. When the pCU has logged out of the secure machine 106, the secure machine driver 118 will let the secure machine 106 know that the pCU has logged out and the session handle used by the secure machine 106 will no longer be valid. The secure machine process will not send/receive any commands to the HSM firmware 116 until a pCU does another login.

In some embodiments, the HSM adapter 102 is configured to allow a single partition to support multiple pCUs. Specifically, the secure machine 106 needs at least one pCU to login to be able to interact with the HSM firmware 116 or receive commands across the PCIe bus. If multiple pCUs login, each login command and the session handle will be passed along to the secure machine 106 so that it can use these session handles in whichever way it wants. When any of the pCUs logs out, the secure machine 106 will be informed about this and the session handle corresponding to that particular pCU will no longer be valid. When the last pCU logs out, the secure machine 106 will no longer be able to send or receive any packets from outside without a pCU logging in.

Even though the secure machine 106 gets full access to library and system calls of the HSM adapter 102, the HSM adapter 102 is configured to enforce a number of restrictions on secure machine processes so that they can safely run within the confines of the secure machine environment 104 without affecting the software running within the FIPS boundary 114 on the HSM adapter 102. Note that all of these permissions and restrictions are inherited and therefore is applicable to every process and thread spawned by the secure machine processes.

For a non-limiting example, since the secure machine process runs with a non-zero UID (user id), referred to as secure machine UID, restricted permissions are necessary. Here, the UID is a user identifier used to determine which system resources a user can access on the HSM adapter 102. In some embodiments, the HSM adapter 102 is configured to grant the permissions on certain paths of the secure machine process based on the UID. Specifically, the secure machine process runs with its working directory as/home/secure machine/cwd, and the secure machine UID is the owner of this directory. All the secure machine package contents are present in home/secure_machine/bin/, which is also owned by the secure machine UID. The HSM adapter 102 is configured to allow the secure machine UID to read, write and execute anything within these directories, which are referred to as SMdir. The directories (and all their subdirectories and files) to which the secure machine UID can only read and execute are referred to as binlibdir. The directories (and all their subdirectories and files) to which the secure machine UID can read but are not executable are referred to as pfsdir (for pseudo filesystem). Once the secure machine initialization process has been launched, the initialization process can launch other processes from all the above directories.

In some embodiments, the secure machine environment 104 runs within a Busybox environment, and hence the secure machine 106 can make use of all the Busybox functionalities such as running shell script or performing an 1s, mkdir command etc. Here, BusyBox is software that provides several stripped-down Unix tools in a single executable file. It runs in a variety of POSIX environments including but not limited to Linux, Android, FreeBSD and others, such as proprietary kernels, although many of the tools it provides are designed to work with interfaces provided by the Linux kernel. It was specifically created for embedded operating systems with very limited resources.

In some embodiments, the entire filesystem 122 of the HSM adapter 102 is of type initramfs, which is a type of filesystem called initial RAM file system, where the entire filesystem runs from within RAM and all the changes made within the filesystem 120 are lost after reboot and the entire filesystem 122 returns back to its initial state. Since the secure machine environment 104 runs with the initramfs filesystem 122, no file created or changed will be part of a permanent storage. The secure machine process can create/read/write/delete its own per-partition blocks, which are part of the HSM adapter's NAND flash storage and hence it will be retained as long as the partition exists. The blocks can be also marked as sharable with the host 108 enabling another application 110 to retrieve the blocks across the PCIe bus.

In some embodiments, the HSM adapter 102 enables debugging of the secure machine 106 and its processes by generating a secure machine system log (syslog) using the log_err( ) log_print( ) and log_debug( ) API. Note that debugging needs to be enabled while creating the secure machine package 120 for the application 110 to be able to retrieve to the debug log. These logs can be extracted out from the HSM adapter 102 by a pCU of that partition.

In cases where a signal is received by a secure machine process, the signal number is captured and written to the SM syslog before passing it on to the secure machine process. In certain cases, a register dump is generated to ease debugging via one of the following signals: SIGILL (illegal instruction), SIGSEGV (segmentation fault), SIGFPE (floating point exception), SIGBUS (bus error), and SIGSYS (bad argument to system call).

In some embodiments, when debug is enabled for the secure machine 106 and its processes, the HSM adapter 102 is configured to generate a core dump file upon receiving any of the signals which cause a core dump (including all the signals discussed above). Here, the core dump includes state of the memory of a computer program at a specific time, generally when the program has crashed The core dump of a crashed secure machine process can be extracted by the pCO to examine what exactly caused a crash if debugging is enabled while generating the secure machine package 120.

FIG. 6 depicts a flowchart of an example of a process to support a secure machine environment on a HSM adapter. Although this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

In the example of FIG. 6, the flowchart 600 starts at block 602, where a secure machine environment is created on a hardware security module (HSM) adapter, wherein the secure machine environment is an operating system (OS) environment on the HSM adapter that allows a user to run a secure machine for a security sensitive application of the user securely within the HSM adapter and to gain access to its security measures. The flowchart 600 continues to block 604, where a command are received from an application running on a host outside of the HSM adapter and having no security sensitive code to execute the security sensitive application of the user within the secure machine environment of the HSM adapter. The flowchart 600 continues to block 606, where all sensitive information of the security sensitive application are processed via one or more processes/threads of the security machine, while the application running on the host deals only with non-security sensitive information of the user. The flowchart 600 ends at block 608, where a response is sent back to the application running on the host following execution of the security sensitive application of the user within the secure machine environment.

The methods and system described herein may be at least partially embodied in the form of computer-implemented processes and apparatus for practicing those processes. The disclosed methods may also be at least partially embodied in the form of tangible, non-transitory machine readable storage media encoded with computer program code. The media may include, for example, RAMs, ROMs, CD-ROMs, DVD-ROMs, BD-ROMs, hard disk drives, flash memories, or any other non-transitory machine-readable storage medium, wherein, when the computer program code is loaded into and executed by a computer, the computer becomes an apparatus for practicing the method. The methods may also be at least partially embodied in the form of a computer into which computer program code is loaded and/or executed, such that, the computer becomes a special purpose computer for practicing the methods. When implemented on a general-purpose processor, the computer program code segments configure the processor to create specific logic circuits. The methods may alternatively be at least partially embodied in a digital signal processor formed of application specific integrated circuits for performing the methods.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Embodiments were chosen and described in order to best describe the principles of the invention and its practical application, thereby enabling others skilled in the relevant art to understand the claimed subject matter, the various embodiments and with various modifications that are suited to the particular use contemplated.

What is claimed is:

1. A system to support a secure machine environment on a hardware security module (HSM) adapter, comprising:
said HSM adapter, which in operation, is configured to:
create a secure machine environment on a hardware security module (HSM) adapter, wherein the secure machine environment is an operating system (OS) environment on the HSM adapter that allows a user to run a secure machine for a security sensitive application of the user securely within the HSM adapter and to gain access to its security measures;
receive a command from an application running on a host outside of the HSM adapter and having no security sensitive code to execute the security sensitive application of the user within the secure machine environment of the HSM adapter;
process all sensitive information of the security sensitive application via one or more processes/threads of the security machine, while the application running on the host deals only with non-security sensitive information of the user;
send a response back to the application running on the host following execution of the security sensitive application of the user within the secure machine environment.

2. The system of claim 1, wherein:
code for the security sensitive application running in the secure machine environment is protected not to be exposed outside of the secure machine environment of the HSM adapter.

3. The system of claim 1, wherein:
the secure machine environment is an OS environment on the HSM adapter, wherein the secure machine environment sets up all necessary security features to allow the secure machine to run inside of it.

4. The system of claim 3, wherein:
the OS environment is Security-Enhanced Linux (SE Linux), which supports access control security policies including mandatory access controls (MAC).

5. The system of claim 1, wherein:
the HSM adapter is a multi-chip embedded Federal Information Processing Standards (FIPS) 140-compliant hardware module with firmware configured to perform secured key management cryptographic operations.

6. The system of claim 5, wherein:
the secure machine environment runs outside FIPS boundary of the HSM adapter and is only allowed to access keys, contexts, and other resources maintained inside the FIPS boundary using handles, which are unique reference numbers to resources maintained inside the FIPS boundary.

7. The system of claim 5, wherein:
the secure machine environment is bound to a specific partition of the HSM adapter, wherein the partition is a block of resources inside the FIPS boundary of the HSM adapter.

8. The system of claim 5, wherein:
the secure machine is configured to receive the command from and send response to the FIPS boundary of the HSM adapter.

9. The system of claim 5, wherein:
the secure machine is configured to be receive the command and send the response only after a partition Crypto User (pCU) logins to a partition of the FIPS boundary of the HSM adapter to confirm its credentials, wherein the partition is a block of resources inside the FIPS boundary of the HSM adapter.

10. The system of claim 1, wherein:
only one secure machine environment runs at a time on the HSM adapter and another secure machine environment starts only after the current one has been stopped and the HSM adapter reboots.

11. The system of claim 1, wherein:
the secure machine includes running a secure machine initiation process and all processes that it spawns, wherein all binaries and files required to run the secure machine are contained inside a secure machine package.

12. The system of claim 11, wherein:
the secure machine package is a compressed file that includes one or more of files in Executable and Linkable Format (ELF) to initialize execution of the secure machine, shared libraries, and signature of the secure machine package signed using a private key.

13. The system of claim 12, wherein:
the security sensitive application is compiled to obtain the ELF files of the secure machine package to be executed by the secure machine on the HSM adapter.

14. The system of claim 1, wherein:
the secure machine is configured to receive the command from and send the response to the application having no security sensitive code running on the host across a PCIe bus.

15. The system of claim 1, wherein:
the secure machine is configured to register a plurality of opcodes that its processes/threads receive with a secure machine driver of the HSM adapter, wherein the opcodes determines how to send the response back to the applications on the host.

16. The system of claim 1, wherein:
the secure machine is configured to send the response only to the host with the request receive id received when the application from the host sends the command to the secure machine.

17. The system of claim 1, wherein:
the HSM adapter is configured to enforce a plurality of restrictions on the secure machine processes so that the security sensitive application run safely within the secure machine environment without affecting other software running on the HSM adapter.

18. The system of claim 1, wherein:
the HSM adapter is configured to adopt an initial RAM file system, wherein the entire filesystem runs from within RAM and all changes made within the filesystem are lost after reboot and the entire filesystem returns back to its initial state.

19. The system of claim 1, wherein:
the HSM adapter is configured to generate a core dump file upon receiving a signal that cause a core dump, wherein the core dump includes state of the application when the application has crashed and is extracted to examine what exactly caused the crash if debugging is enabled.

20. A method to support a secure machine environment on a hardware security module (HSM) adapter, comprising:
creating a secure machine environment on a hardware security module (HSM) adapter, wherein the secure machine environment is an operating system (OS) environment on the HSM adapter that allows a user to run a secure machine for a security sensitive application of the user securely within the HSM adapter and to gain access to its security measures;
receiving a command from an application running on a host outside of the HSM adapter and having no security sensitive code to execute the security sensitive application of the user within the secure machine environment of the HSM adapter;
processing all sensitive information of the security sensitive application via one or more processes/threads of the security machine, while the application running on the host deals only with non-security sensitive information of the user;
sending a response back to the application running on the host following execution of the security sensitive application of the user within the secure machine environment.

21. The method of claim 20, further comprising:
Protecting code for the security sensitive application running in the secure machine environment not to be exposed outside of the secure machine environment of the HSM adapter.

22. The method of claim 20, further comprising:
running the secure machine environment outside of Federal Information Processing Standards (FIPS) boundary of the HSM adapter and allowed the secure machine environment only to access keys, contexts, and other resources maintained inside the FIPS boundary using handles, which are unique reference numbers to resources maintained inside the FIPS boundary.

23. The method of claim 22, further comprising:
binding the secure machine environment to a specific partition of the HSM adapter, wherein the partition is a block of resources inside the FIPS boundary of the HSM adapter.

24. The method of claim 22, further comprising:
receiving the command from and sending response to the FIPS boundary of the HSM adapter.

25. The method of claim 22, further comprising:
receiving the command and sending the response only after a partition Crypto User (pCU) logins to a partition of the FIPS boundary of the HSM adapter to confirm its credentials, wherein the partition is a block of resources inside the FIPS boundary of the HSM adapter.

26. The method of claim 20, further comprising:
running only one secure machine environment runs at a time on the HSM adapter and starting another secure machine environment only after the current one has been stopped and the HSM adapter reboots.

27. The method of claim 20, further comprising:
running the secure machine includes running a secure machine initiation process and all processes that it spawns, wherein all binaries and files required to run the secure machine are contained inside a secure machine package.

28. The method of claim 27, further comprising:
including a compressed file in the secure machine package, wherein the compressed file includes one or more of files in Executable and Linkable Format (ELF) to initialize execution of the secure machine, shared libraries, and signature of the secure machine package signed using a private key.

29. The method of claim 28, further comprising:
compiling the security sensitive application to obtain the ELF files of the secure machine package to be executed by the secure machine on the HSM adapter.

30. The method of claim 20, further comprising:
receiving the command from and sending the response to the application having no security sensitive code running on the host across a PCIe bus.

31. The method of claim 20, further comprising:
registering a plurality of opcodes that its processes/threads receive with a secure machine driver of the HSM adapter, wherein the opcodes determines how to send the response back to the applications on the host.

32. The method of claim 20, further comprising:
sending the response only to the host with the request receive id received when the application from the host sends the command to the secure machine.

33. The method of claim 20, further comprising:
enforcing a plurality of restrictions on the secure machine processes so that the security sensitive application run safely within the secure machine environment without affecting other software running on the HSM adapter.

34. The method of claim 20, further comprising:
adopting an initial RAM file system, wherein the entire filesystem runs from within RAM and all changes made within the filesystem are lost after reboot and the entire filesystem returns back to its initial state.

35. The method of claim 20, further comprising:
generating a core dump file upon receiving a signal that cause a core dump, wherein the core dump includes state of the application when the application has crashed and is extracted to examine what exactly caused the crash if debugging is enabled.
